(19) United States
(12) Patent Application Publication
(10) Pub. No.: US 2026/0360147 A1
(43) Pub. Date: Nov. 12, 2026

(54) SCALABLE EVENT-BASED VIDEO STREAMING SYSTEMS AND METHODS

(71) Applicant: BAYLOR UNIVERSITY, Waco, TX (US)

(72) Inventor: Andrew C. Freeman, Waco, TX (US)

(73) Assignee: BAYLOR UNIVERSITY, Waco, TX (US)

(21) Appl. No.: 19/668,019

(22) Filed: May 5, 2026

Related U.S. Application Data
(60) Provisional application No. 63/802,129, filed on May 8, 2025.

(51) Int. Cl. G06V 20/40; G06V 10/60

(52) U.S. Cl. CPC G06V 20/44; G06V 10/60

(57) ABSTRACT

A system for event-based video streaming, comprising an event-based video data processor configured to receive intensity data and to generate event-based video data as a function of pixel brightness and a router configured to assign the event-based video data to a subgroup having a predetermined latency and to select whether to transmit the subgroup to a first processor or a second processor as a function of the latency.

### RELATED APPLICATIONS

This application claims benefit of and priority to U.S. Provisional Patent Application no. 63/802,129, filed May. 8, 2025, which is hereby incorporated by reference for all purposes as if set forth herein in its entirety.

### TECHNICAL FIELD

The present disclosure relates generally to video data processing systems, and more specifically to scalable event-based video streaming systems and methods that optimize data transmission bandwidth and data processing resources for event-based video data.

### BACKGROUND OF THE INVENTION

Event-based video data systems are known in the art, but can generate large amounts of data that is difficult to compress, unlike frame-based video data.

### SUMMARY OF THE INVENTION

A system for event-based video streaming is provided that includes an event-based video data processor configured to generate event-based video data as a function of pixel brightness and a relay configured to assign the event-based video data to a subgroup having a latency target predetermined by the receiver, and to simultaneously transmit the data to multiple receivers with different latency targets.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of a system for providing heterogeneous applications, in accordance with an example embodiment of the present disclosure;

FIG. 2 is a diagram of a partitioning scheme, in accordance with an example embodiment of the present disclosure;

FIG. 3 is a diagram of a system for scalable event-based video streaming, in accordance with an example embodiment of the present disclosure;

FIG. 4 is a diagram of an algorithm for scalable event-based video streaming, in accordance with an example embodiment of the present disclosure;

FIG. 5A is a diagram of a system for processing event-based video data, in accordance with an example embodiment of the present disclosure; and

FIG. 5B is a diagram of a system for processing event-based video data, in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

Video streaming consumes a substantial amount of Internet traffic. There has been progress in the underlying video codecs, the adaptation mechanisms, and the streaming protocols to address the problems associated with that bandwidth usage. Scalable video coding (SVC) showed early promise with its enhancement layer mechanism, but decoder overhead has limited its adoption. Adaptive bitrate (ABR) streaming is common, but also fails to address these problems effectively.

Neuromorphic “event” sensors can be used to record video with asynchronous pixel samples rather than image frames. Event sensors do not capture image frames, and instead sense each pixel asynchronously, outputting a discrete timestamped “event” when its log intensity change exceeds a certain threshold. Since intensity change occurs most dramatically at points of high contrast change, a stationary event camera predominantly outputs events for the edges of moving objects. These cameras achieve microsecond temporal resolution, high dynamic range (>120 dB), and low power usage, but suffer from extremely high data rates. Event-based computer vision applications have shown compelling performance, but their relative slowness and power usage undermines many of the benefits of the sensor technology.

Event sensors can be used for computer vision applications. Research efforts for event sensors have primarily focused on application development and not on problems associated with data transmission. Event-based video representations may also be produced by transcoding frame-based video, including point cloud representations and neural representations. The present disclosure addresses the use of streaming protocol mechanisms for reducing the data bandwidth of arbitrary spatiotemporal event representations, so long as the event data may be encoded through Multiple Description Coding.

The present disclosure provides systems and methods for event compression and streaming for rate-adaptive event streaming, including a new format for streaming event data in a scalable manner. This format takes advantage of data agnosticism to achieve low latency and scalable adaptation using existing protocol mechanics.

A pixel in an event camera continuously measures the log of the incident light intensity. When the log intensity changes beyond a predetermined threshold (i.e. gets brighter or darker by a certain amount), the camera outputs a sequence of tuples, each having the form ⟨𝑥, 𝑦, 𝑡, 𝑝⟩, where 𝑥 and 𝑦 are the spatial coordinates, 𝑡 is a microsecond-resolution timestamp, indicating the precise moment that the change threshold was met, and 𝑝 is the 1-bit change polarity. In contrast, traditional cameras have a fixed data rate in the uncompressed representation, and the raw data rate for event cameras depends entirely on the amount of motion being recorded. Under high motion, a 720p event camera can easily produce raw data at a rate exceeding 500 Mbps, compared to a fixed rate of 221 Mbps for a monochrome framed camera at 30 FPS. The microsecond temporal precision and 32-bit timestamps of a typical event camera give it a high-speed view of the world similar to that of a 1-million FPS framed camera, at a fraction of the raw data rate, weight, and power consumption. Since the data is spatiotemporally sparse and does not express absolute intensities, however, these cameras are typically designed for computer vision applications, rather than human viewership.

With the high data rate demands of event cameras, many computer vision applications require significant computational and energy resources to operate. Although specialized neuromorphic application hardware can dramatically increase efficiency, graphics processing units (GPUs) are much more common in the literature due to their accessibility and support infrastructure. For GPU-based applications, an event stream can be converted to a variety of frame-based representations, such as event polarity and event count histograms, Surface of Active Events (SAE), voxel grids and Event Pillars. To maintain “real-time” performance, these GPU-based applications will typically temporally group the events into framed representations at a frequency determined by the inference speed. Many applications that operate at a rate of 20-100 Hz will claim to be “real-time,” based on that architecture. While such a claim is reasonable with a frame-based camera, it is less convincing for an event camera that can record with 1 million Hz precision. If events are streamed between devices on the same network (e.g. from a CPU of a small robot to a more powerful data processor such as a GPU-based server), then the distance is extremely short. Some efforts have explored lossless compression of event data; however, many event-based vision applications can maintain high accuracy when many events are discarded entirely.

In one example embodiment, the present disclosure can be used for an event-based GPU application for an event camera mounted aboard a small robot, such as a drone, to allow application processing to be performed remotely. The event camera can have lower power and weight requirements than a traditional camera, allowing for a smaller robot or longer deployment. To get the event stream from the robot to the GPU server, consider an example where the GPU can perform object detection inference in 5 ms and is operated at 200 Hz to utilize the event camera’s high temporal resolution. Since the GPU performs object detection on a frame-based representation, the first intuitive approach might be to cast the events into the framed representation and encode it with standard video codecs (e.g. H.264 or H.265) for streaming. However, this approach is fundamentally limited by the maximum encoding speed on low power hardware. There is significant additional overhead in the transcoding and packaging of videos for live streaming, which is necessary to accommodate changes in network bandwidth.

To perform high-rate application inference, it is necessary to consider streaming the event data itself. Because event cameras can generate millions of events per second during high-motion scenarios, for a high-resolution camera, each raw event typically requires 8-16 bytes to encode. Even at low activity levels of 100K events per second, this event rate produces a raw data rate of 6.4-12.8 Mbps. During high motion activity, this event rate would accordingly scale, likely overwhelming the connection to a GPU server. Standard lossless compression techniques (e.g., gzip, LZ4 and xz) offer some relief but do not attain compelling compression ratios or speeds. More importantly, lossless compression cannot adapt to changing network conditions. When bandwidth becomes constrained, the system has no way to gracefully degrade performance.

Therefore, practical event-based vision systems require lossy, rate-adaptive compression and streaming algorithms specifically designed for event data. Such a system should preserve the microsecond temporal precision of the events and spatial resolution of the sensor, dynamically adjust compression rates based on network conditions and application latency requirements, scale efficiently with the camera resolution, event rate, and network configurations, and meet other requirements as discussed and disclosed herein.

Existing techniques for event compression are frequently lossless. The event camera manufacturers typically have a proprietary compressed data format, such as AEDAT for iniVation sensors and EVT for Prophesee sensors. These lightweight formats are designed for on-camera compression to prevent bottlenecking over a USB connection to a computer. A straightforward method for inducing loss without quantization is to simply discard some subset of the event stream. In the context of object detection, the present disclosure provides embodiments that are resilient to dramatic reductions in the raw event stream.

In one example embodiment, a suitable protocol such as the moq-transfork version 0.2.0 (commit ID 34a6177) and its associated Rust packages of the Media Over QUIC (MoQ) protocol of the Internet Engineering Task Force, available at www.datatracker.ietf.org/wg/moq/documents/, or other suitable protocols can be used to construct a number of stream “tracks” at a sender. To construct stream tracks, the event stream can be partitioned by sending an MoQ object of up to 𝐸 consecutive events on each track, such as at fixed time intervals of 50 ms or other suitable values (such as to match an inference window of a Recurrent Vision Transformer or for other suitable purposes), to create natural join points in the stream. The receiver can then subscribe and unsubscribe from tracks as needed to maintain a given latency target.

Time-based event partitioning is a reasonable mechanism to enable rate adaptation, but using multiple tracks with simultaneous subscriptions may introduce limitations. For example, scalability may be severely limited by the overhead of concurrent transport streams. During bandwidth-limited scenarios, tracks may become desynchronized from one another, such as where a lower-priority track lags 50 ms or more behind a higher-priority track at the relay, due to the relay delaying the sending of the lower-priority data. If the client is not made aware of the internal relay processes, it may await the arrival of the delayed objects, increasing the end-to-end latency. This problem can be exacerbated by frequent subscription changes (possibly dozens per second) and extreme variation in the source data rate (based on the amount of motion in the scene). Although this desynchronization can be detected at the client and an affected track can be unsubscribed from, there might be no mechanism for the client to reset the internal relay state when the system resubscribes to the track, and the track delay may persist. The present disclosure addresses those and other problems.

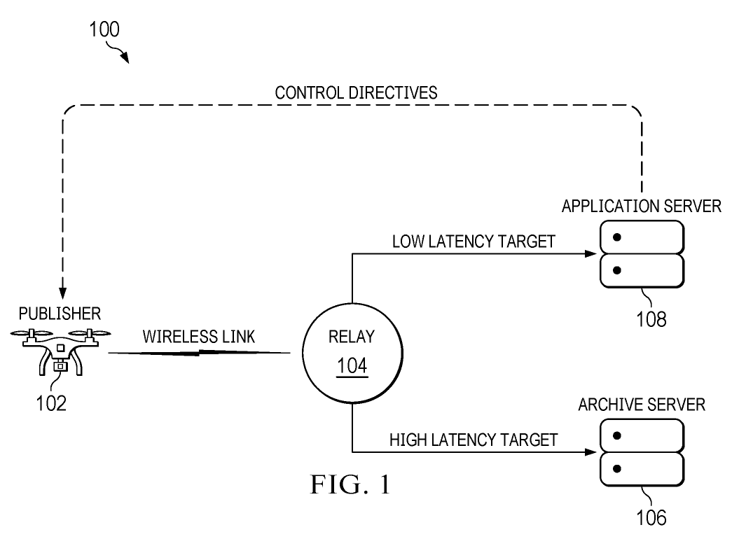

FIG. 1 is a diagram of a system 100 for providing a heterogeneous application, in accordance with an example embodiment of the present disclosure. System 100 includes publisher 102, relay 104, archive server 106 and application server 108, each of which can be implemented in hardware or a suitable combination of hardware and software,

A low-latency receiver at application server 108 can set a short delivery timeout for its MoQ subscription, and can receive a subset of the event data at high speed/low latency. Vision application results can then be used to send control directives back to publisher 102, such as a drone device, to perform operations such as obstacle avoidance. At the same time, another receiver such as archive server 106 can receive all of the available data for archival purposes, albeit with higher latency, by simply setting a high delivery timeout for its subscription.

Furthermore, a publisher device can be configured to detect a minimum target latency. The choice of 𝐸 (how many events to send per track, per unit time) may directly correspond to the minimum latency achievable by a client. For example, it can be set to maintain 5 ms when 𝐸 = 250, but 50 ms when 𝐸 = 2500, or other suitable values. With a small, fixed number of tracks, such as 𝑁 = 5, the maximum quality of the received event stream can be further limited. This configuration might inhibit the ability to support heterogeneous applications.

For example, system 100 illustrates a publisher 102 such as a drone device sending its event camera data to two subscribers such as archive server 106 and application server 108 through a relay 104. A GPU server has a low latency target, so it can be tolerant to heavy data loss, can compute an application result, such as object detection, and can send flight control directives to the drone (possibly via the same, bidirectional MoQ Transport connection). At the same time, storing as much data as possible from the camera on a secure archival server can be accomplished, irrespective of the latency incurred. With a fixed budget for 𝑁 and 𝐸, it may not be possible to satisfy these diverse latency goals simultaneously. If low latency is necessary, publisher 102 might be unable to send all the data from the camera. This server-side adaptation can impact the ability to scale such a system to multiple receivers with their own application-level goals.

Using subgroup-based event partitioning can provide an additional level of granularity to the structure of data streams, where a group can optionally have a suitable number of subgroups. A relay can be used to attempt to deliver the data from these subgroups according to the underlying subgroup priority and object IDs. With this modification to system 100, independent data streams can remain in temporal synchronization within a single-track subscription.

A delivery timeout mechanism can also or alternatively be used, such as where the subscriber sets the maximum duration that the relay may spend attempting to forward an object. If the timeout duration is reached and the object has not been sent successfully, it can be dropped for that subscription.

Using sub-groups and delivery timeout, event data can be partitioned for scalable streaming. Rather than sending events across separate tracks, they can be partitioned across several subgroups in a single track. Each object can hold a fixed number of events, 𝐸, and these objects can be placed into subgroups according to their temporal order. Subgroups can hold a variable number of objects per unit time, and each higher-level subgroup can have at least as many objects as the preceding subgroup. Every 𝑇 milliseconds, the subgroup ID can be reset to 0. Priority can be determined by the subgroup ID, with subgroup 0 having the highest priority.

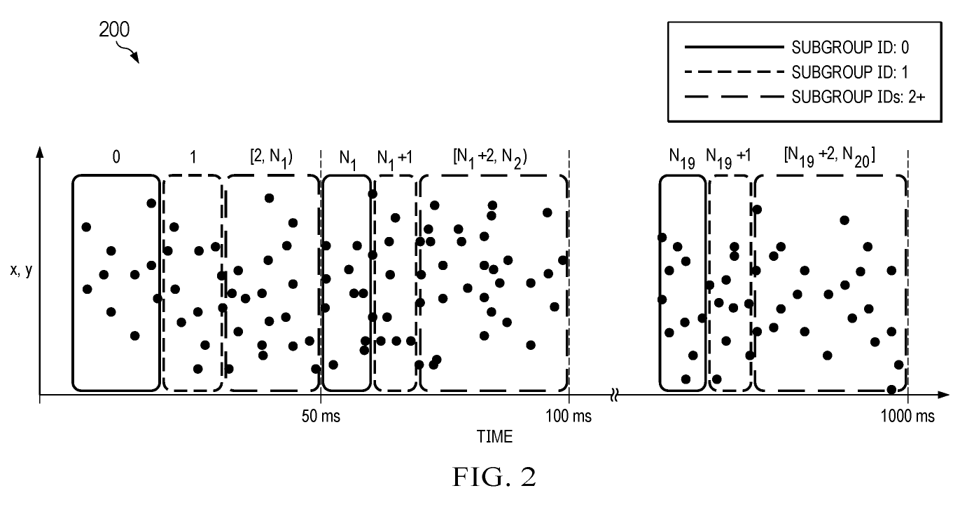

FIG. 2 is a diagram 200 of a partitioning scheme, in accordance with an example embodiment of the present disclosure. For this example, 𝐸 = 10 events per object, and the object IDs are written across the top of diagram 200. Subgroups 0 and 1 in this example each have one object per 𝑇 = 50 ms time window. A variable number of subgroups can be used depending on the overall number of events per 𝑇 window.

By setting a predetermined delivery timeout for the subscription, the relay will not block the progression of any subgroup stream. Since the received data rate is not determined by subscribing and unsubscribing to tracks, the delivery timeout becomes the primary adaptation mechanism. If it is assumed that the objects arrive at the relay instantaneously when they are generated by the event data source, then a fixed delivery timeout can ensure that the end-to-end latency is within a predetermined target. However, if the connection between the publisher and the relay experiences congestion, the received latency can be improved by decreasing the delivery timeout for the subscription.

While a large number of subscription control messages per second are needed to adapt to the changes in both the camera data rate and the overall network bandwidth, the protocol of diagram 200 allows the client to adapt only to changes in the network bandwidth. In the typical case, only a few delivery timeout messages per minute would be expected.

While supporting low-latency applications, a separate, higher-latency subscriber, such as archive server 106, can initiate a connection with a high delivery timeout. This higher-latency subscriber will have fewer objects dropped by the relay because of the longer timeout. This configuration allows different subgroup event rates to be used without changing the receiver-driven adaptation algorithm. For example, the number of objects per subgroup can be increased per unit time by a factor of 2 for each increment of the subgroup ID. Then, lower-priority subgroups can be used to carry more event data but will be less likely to successfully send all their data when there are periods of congestion.

The present disclosure can be used with a single relay, to prevent delivery timeouts from being propagated by relays from the subscribers to the publishers. If multiple relays are used, they can be configured to communicate a relay-specific delivery timeout to each new subscriber. If the relay-specific delivery time-out information is cumulative, the subscriber can be informed of the maximum duration for an object to propagate through all the relays. If the maximum duration is less than the application’s target latency, the subscriber can set the delivery timeout to the difference between the target latency and the cumulative relay timeouts. This technique would still be limited if early relays have short timeouts and could be mitigated if a relay opens multiple subscriptions to the same published track, but with different delivery timeouts. Connection management processes can be used to avoid sending duplicate objects and to make objects received in a lower-latency subscription available to the higher-latency subscription.

For compression support, variably sized subgroups can be used in compression schemes for event data, to achieve a more accurate probability model and higher compression ratios when events are closely located in both space and time. This configuration can benefit from longer, continuous segments of events in the same compression context. Therefore, lower-priority subgroups can be expected to achieve better compression characteristics. If an object is dropped, subsequent objects in the subgroup cannot be decoded. However, other subgroup streams may still be decoded and the resulting event streams merged in one reconstructed representation. The publisher’s choice of group interval determines the maximum duration that the receiver may wait before the decoder context is reset for a given subgroup ID.

A single-track adaptation scheme can maintain extremely low latency but is likely ill-suited for traditional video data types and can instead be used in applications that are not subject to conventional metrics for video quality. Classical streaming solutions seek to maximize the human quality of experience (QoE) by gradually adjusting the visual quality over time. In contrast, event cameras designed for computer vision applications that use event video are largely inscrutable for human viewers, even when there is no data loss. Similarly, point cloud representations may be leveraged for both human and vision application consumption, and visual quality measurements are viewpoint-dependent. The present disclosure thus maximizes both the viewer-level and application-level performance at a given latency target, without requiring explicit quality adaptation.

While a custom Real-time Transport Protocol (RTP) can yield lower latency than MoQ, the present disclosure is directed to receiver-driven adaptation mechanisms for event streaming. The exact latency measurements are unimportant, so long as the application-level performance can map to the latency (and loss) in a predictable manner. Lower latency than MoQ can achieve can be accomplished with RTP-based protocols (e.g., with RTP Over QUIC) using similar adaptation mechanisms.

Event cameras can be paired with traditional frame- based cameras. Framed sensors provide complementary information to the event representations, including absolute intensities (rather than intensity changes). As such, they can enhance the application results beyond what either imaging modality can achieve in isolation. The ongoing MoQ efforts in frame-based streaming can be integrated directly alongside new event-based format.

Framed sensors or video sources such as rendered graphics engines can also be integrated in this system, so long as the frames are transcoded to a spatiotemporal event representation. Likewise, stereo sensor configurations and LiDAR sensors that produce point cloud representations can be integrated in this system. The depth dimension z of a point cloud representation may simply map to t of a typical event representation, and the intensity measurements may convey absolute intensity rather than the relative intensity of an event camera.

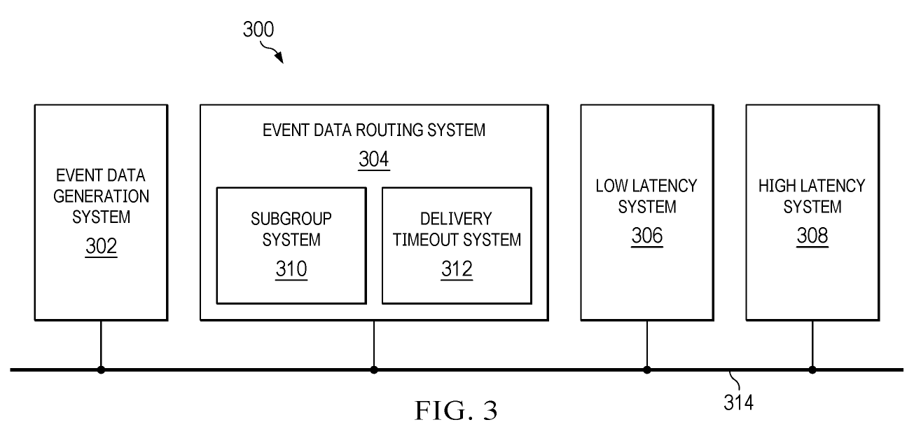

FIG. 3 is a diagram of a system 300 for scalable event-based video streaming, in accordance with an example embodiment of the present disclosure. System 300 includes event data generation system 302, event data routing system 304, low latency system 306, high latency system 308, subgroup system 310, delivery timeout system 312 and network 314, each of which can be implemented in hardware or a suitable combination of hardware and software. System 300 can also or alternatively include features and processes discussed and described herein, and those features and processes will be apparent to a person of skill in the art and are not repeated here.

Event data generation system 302 can be implemented as one or more algorithms that are stored in data memory and loaded into the working memory of a processor, that cause the processor when executed to receive intensity data and generate event data. In one example embodiment, event data generation system 302 can be a component of an event data camera that generates image-related event data or other suitable data, such as hybrid event and frame-based image data.

Event data routing system 304 can be implemented as one or more algorithms that are stored in data memory and loaded into the working memory of a processor, that cause the processor when executed to route event data from event data generation system 302 to receivers, such as low latency system 306 and high latency system 308. In one example embodiment, event data routing system 304 can perform additional processing associated with routing data as a function of whether the data is low latency, high latency, has timed out or for other suitable purposes.

Low latency system 306 can be implemented as one or more algorithms that are stored in data memory and loaded into the working memory of a processor, that cause the processor when executed to receive and process low latency event data, such as to buffer the event data and to process it in conjunction with previously received low latency event data. Low latency system 306 can also send control directives over network 314 to event data generation system 302, such as to change operational parameters of data generation system 302, to change operational parameters of an associated system (e.g. to change an intersection control light state from green to red), or for other suitable processes.

High latency system 308 can be implemented as one or more algorithms that are stored in data memory and loaded into the working memory of a processor, that cause the processor when executed to receive and process high latency event data, such as to buffer the event data and to process it in conjunction with previously received high latency event data. High latency system 308 can also send control directives over network 314 to event data generation system 302, such as to change operational parameters of data generation system 302, to change operational parameters of an associated system (e.g. to generate an intruder alarm condition), or for other suitable processes.

Subgroup system 310 can be implemented as one or more algorithms that are stored in data memory and loaded into the working memory of a processor, that cause the processor when executed to group event data into subgroups with an associated latency. In one example embodiment, subgroup system 310 can group events into low latency groups and high latency groups, can change the latency classification of event data, can route subgroup data or change subgroup data routing and can perform other suitable processes.

Delivery timeout system 312 can be implemented as one or more algorithms that are stored in data memory and loaded into the working memory of a processor, that cause the processor when executed to terminate an identified subgroup if it times out under the latency rules for that subgroup. In one example embodiment, a subgroup can be assigned a low or high latency based on an associated application, where time out of the subgroup under the latency rules results in termination of that subgroup. In another example application, the subgroup can be transferred between low and high latency subgroups, where the low latency subgroup is terminated and a new high latency subgroup is instantiated, or other suitable processes can also or alternatively be implemented.

Network 314 can be implemented as one or more algorithms that are stored in data memory and loaded into the working memory of one or more processors, that cause the processors when executed to transfer data over associated data communications media.

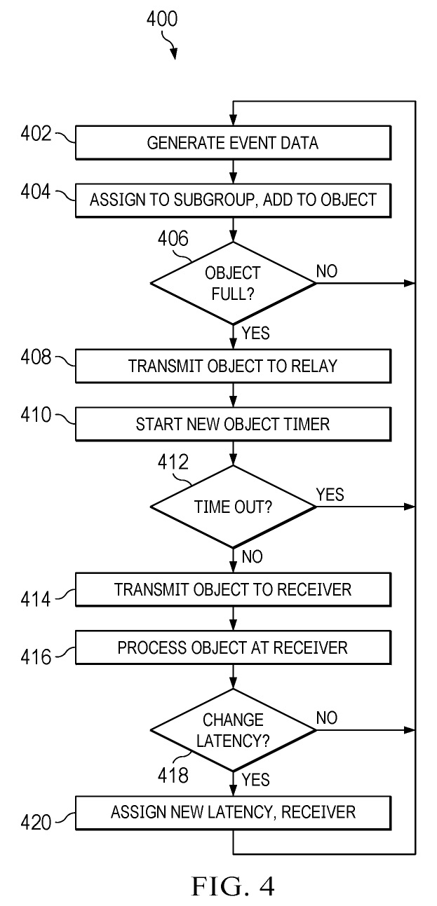

FIG. 4 is a diagram of an algorithm 400 for scalable event-based video streaming, in accordance with an example embodiment of the present disclosure. Algorithm 400 can be implemented in hardware or a suitable combination of hardware and software. Algorithm 400 can also or alternatively include features and processes discussed and described herein, and those features and processes will be apparent to a person of skill in the art and are not repeated here.

Algorithm 400 begins at 402, where event data is generated. In one example embodiment, event data can be generated using an event camera such as a neuromorphic camera, a silicon retina, a dynamic vision sensor or other suitable sensors that generate asynchronous data in response to local changes in brightness, as opposed to fixed-frame images, such as by detecting and recording individual pixel-level brightness changes (events) asynchronously. The algorithm then proceeds to 404.

At 404, event data is assigned to a subgroup, such as by using one or more algorithms operating on a processor that configure the processor to receive the event data and to store the event data in a buffer associated with the subgroup. The data can also be added to an object associated with the subgroup or other suitable objects by one or more algorithms operating on the processor. The algorithm then proceeds to 406.

At 406, the algorithm determines whether the object is full. In one example embodiment, the object can have a predetermined number of bytes of space allocated, can have a predetermined number of events or can have other suitable parameters that can be queried to determine whether the object is full. If it is determined that the object is not full, the algorithm returns to 402, otherwise the algorithm proceeds to 408.

At 408, the object is transmitted to a relay. In one example embodiment, transmission to the relay can include router traversal, network address translation or other suitable processes. The algorithm then proceeds to 410.

At 410, a new object timer is started. In one example embodiment, the object timer can be associated with a latency variable of the object, such as a short timer for low latency, a long timer for high latency or other suitable timers. The algorithm then proceeds to 412.

At 412, it is determined whether the timer has timed out. In one example embodiment, the timer can measure intervals between objects or other suitable processes can also or alternatively be used. If it is determined that the timer has timed out, the algorithm returns to 402, otherwise the algorithm proceeds to 414.

At 414, the object is transmitted to an associated receiver. In one example embodiment, the object can be transmitted from a relay to a receiver or other suitable processes can be used. The algorithm then proceeds to 416.

At 416, the object is processed at the receiver. In one example embodiment, the receiver can process the data for a predetermined function, such as to determine and classify a change in one or more objects in the image data. The algorithm then proceeds to 412.

At 418, it is determined whether there has been a change of latency in for the object. In one example embodiment, if a change in latency has occurred, such as if the low latency data has become high latency data, the algorithm proceeds to 420. If no change in latency has occurred, the algorithm returns to 402.

At 420, control data is generated. In one example embodiment, the control data can be generated to change an object latency, to change a receiver associated with an object or other suitable control data can also or alternatively be generated and transmitted to an event data routing system or other suitable devices. The algorithm then returns to 402.

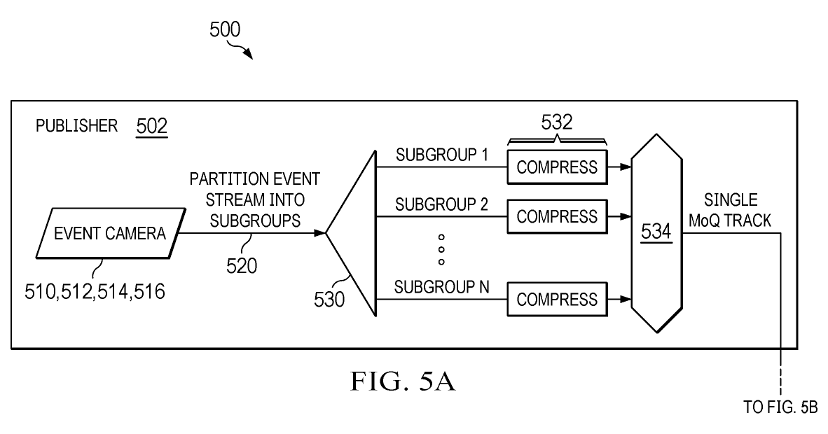

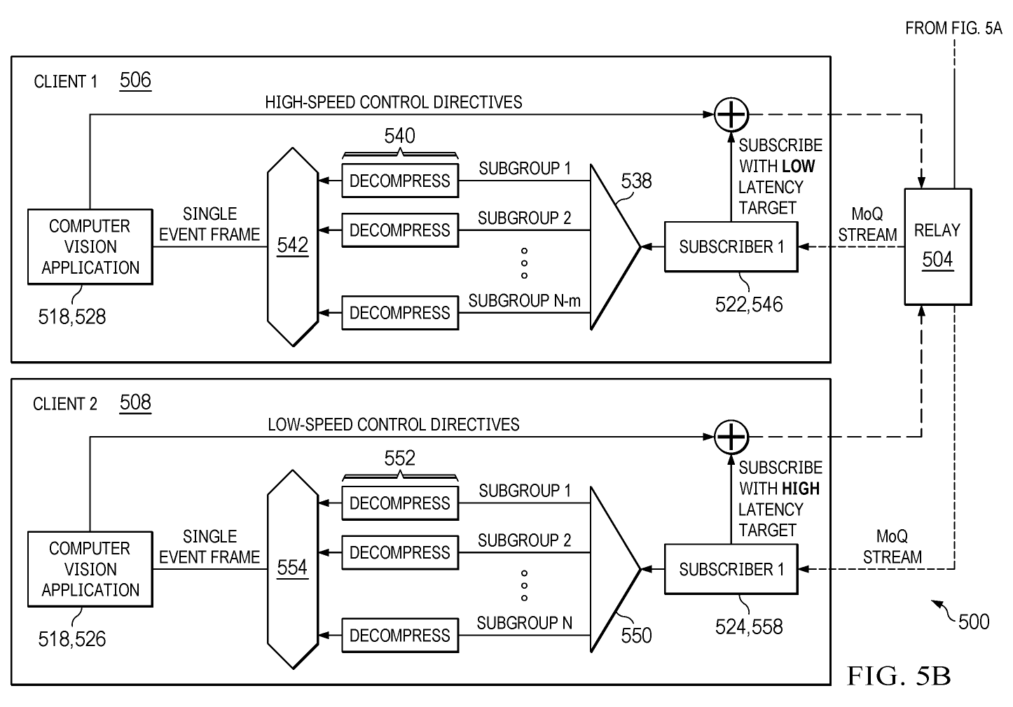

FIG. 5A and 5B is a diagram of a system 500 for processing event-based video data, in accordance with an example embodiment of the present disclosure. System 500 includes publisher system 502, relay system 504, client 1 system 506, client 2 system 508 and associated subsystems and components, each of which can be implemented in hardware or a suitable combination of hardware and software. System 500 can also or alternatively include features and processes discussed and described herein, and those features and processes will be apparent to a person of skill in the art and are not repeated here.

Publisher system 502 can be implemented in hardware or in a suitable combination of hardware and software and can include a suitable number of imaging sensors that produce event-based representation data. In one example embodiment, publisher system 502 can be implemented with monochrome cameras that produce a single channel of polarity events or intensity measurement. Publisher system 502 can also or alternatively be implemented with multi-channel color sensing by expanding the event or point tuple representations or in other suitable manners.

Relay system 504 can be implemented in hardware or in a suitable combination of hardware and software and can receive an MoQ track and select one or more clients for receiving the MoQ track. In one example embodiment, relay system 504 can coordinate with additional relays over a network. The data can be allocated to one or more subgroups or other suitable categories, where subgroups with lower identification numbers can be assigned a higher priority for transmission at the relay, or other suitable processes can also or alternatively be used.

Client 1 system 506 can be implemented in hardware or in a suitable combination of hardware and software and can include a computer vision application or other suitable applications that receive a single event stream from a multiplexer. In one example embodiment, the output of the computer vision application is provided as a high-speed control directive with a subscribe command from subscriber one, with a low latency target.

Client 2 system 508 can be implemented in hardware or in a suitable combination of hardware and software and can include a computer vision application or other suitable applications that receive a single event stream that has contains multiplexed decompressed subgroup data. In one example embodiment, the output of the computer vision application is provided as a low-speed control directive with a subscribe command from subscriber one, with a high latency target.

Event camera 510 can be implemented as a DVXplorer sensor available from iniVation of Zurich, Switzerland, a Metavision® GenX320 sensor available from Prophesee of Paris, France, or other suitable sensors. Framed camera 512 can be implemented as one or more suitable traditional digital video recording devices. In one example embodiment, a combination of event camera 510 and framed camera 512 can be implemented as a DAVIS 346 sensor available from iniVation of Zurich, Switzerland.

Stereo cameras 514 can be implemented as a ZED 2i Stereo Camera available from StereoLabs of San Francisco, California, or other suitable sensors. LiDAR camera 516 can be implemented as a 4D Lidar L1 camera from Unitree of Hangzhou, China, a Moose 3D Scanner available from 3D Makerpro of Shenzhen, China, or other suitable sensors.

Event-based data fusion 518 can be implemented in hardware or a suitable combination of hardware and software that incorporates the complementary data from both framed and event cameras and produces an event-based output as part of a computer vision application. In one example embodiment, algorithms that produce a framed reconstruction which may then undergo a conversion to an event-based representation can be used, such as the ADΔER framework discussed at Freeman, Andrew C. “adder-viz: Real-Time Visualization Software for Transcoding Event Video,” Proceedings of the 33rd ACM International Conference on Multimedia, 2025, which is hereby incorporated by reference for all purposes as if set forth herein in its entirety, or other suitable systems and processes can also or alternatively be used. Event transcoder 520 can be implemented using the ADΔER transcoder framework or other suitable methods to partition an event stream int subgroups.

Temporal grouping processes 522 and 524 can be implemented in hardware or a suitable combination of hardware and software and can extract a fixed- or variable-duration subsequence of events from an event data stream at a subscriber to produce a discrete event “frame.” The temporal dimension of the event frame can be mapped to the third spatial dimension of a point cloud frame or Gaussian representation frame, so that identical compressors may be utilized for all the given data sources, neural representation producers can be used, or other suitable processes can also or alternatively be used.

Selection process 526 can be implemented in hardware or a suitable combination of hardware and software of a computer vision application and can generate data that identifies the available sensor setups that are being used. Downstream processing can be identical for all indicated sensor types if the representations at this stage are all event frames, or other suitable processes can also or alternatively be used. In one example embodiment, each event frame can map to an MoQ Object or other suitable objects or variables.

Process 528 can be implemented in hardware or a suitable combination of hardware and software of a computer vision application and can partition event frames into MoQ subgroups. In one example embodiment, process 528 can be based on random event sampling, temporal division, entropy for mesh or Guassian splat representations, semantic classification, or other suitable methods.

Router 530 can be implemented in hardware or a suitable combination of hardware and software and can route data assigned to subgroups 1 through N to an associated compression system 532.

Compression systems 532 can be implemented in hardware or a suitable combination of hardware and software and can perform compression algorithms of the ADΔER transcoder framework, Gaussian splat compression, the V-PCC encoder of MPEG, or other suitable compression algorithms.

Process 534 can be implemented in hardware or a suitable combination of hardware and software and can multiplex the compressed subgroup Objects into a single MoQ track and publish it to the MoQ relay. The MoQ track is transmitted to relay system 504.

Subscribers can be implemented in hardware or a suitable combination of hardware and software and can initiate a connection with relay system 504. Client 1 can initiate the connection with a low latency target (such as through the MoQ DELIVERY_TIMEOUT parameter or in other suitable manners) in option 546, while Client 2 can initiate a connection with a high latency target in option 558. Relay system 504 can distribute to both client subscribers only the subgroup Objects that can be delivered within the time requirement imposed by the subscription latency target.

Demultiplexers 542 and 554 can be implemented in hardware or a suitable combination of hardware and software and can divide the received data stream into the original subgroups produced by publisher system 502. Any clients, especially those with low latency targets, may receive only a subset of the original subgroups.

Decompressors 540 and 552 can be implemented in hardware or a suitable combination of hardware and software and can decode compressed data, producing multiple event frame representations. Multiplexers 538 and 550 can be implemented in hardware or a suitable combination of hardware and software and can combine the multiple event frames into a single event frame.

Computer vision applications can be implemented in hardware or a suitable combination of hardware and software and can process the reconstructed event frames for a predetermined task. These applications can include object detection, 3D scene reconstruction, facial recognition, feature tracking, and other suitable applications. Based on the results of these applications, clients 1 and 2 can send robotic control directives back to publisher system 502 through options 546 and 558, respectively. The control messages can be sent along the same bidirectional QUIC streams managed by relay system 504.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general-purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general-purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for event-based video streaming, comprising:
an event-based video data processor configured to receive intensity-based data and to generate event-based video data as a function of pixel brightness; and
a router configured to assign the event-based video data to a subgroup having a predetermined latency and to select whether to transmit the subgroup to one or more processors as a function of the latency.

2. The system of claim 1 wherein the one or more processors are low-latency processors and are configured to detect and process events at a latency that is less than a threshold.

3. The system of claim 2 wherein a second processor is a high-latency processor and is configured to detect and process events at a latency that is less than a threshold.

4. The system of claim 1 wherein the event-based video data processor comprises an event camera configured to asynchronously detect pixel-level brightness changes and to generate a sequence of tuples comprising one or more of spatial coordinate data, timestamp data, and change of polarity data for a detected brightness change.

5. The system of claim 1 wherein the router is further configured to assign the event-based video data to one or more of a plurality of subgroups within a single track, wherein each subgroup has a transmission priority determined by a subgroup identifier.

6. The system of claim 5 wherein one of the subgroups having a lower subgroup identifier is assigned a higher priority for transmission than one of the subgroups having a higher subgroup identifier.

7. The system of claim 5 wherein one of the subgroups having a higher subgroup identifier is assigned a higher priority for transmission than one of the subgroups having a lower subgroup identifier.

8. The system of claim 1 wherein the router is further configured to assign the event-based video data to one or more of a plurality of tracks, wherein each track has a transmission priority determined by a subgroup identifier.

9. The system of claim 5 wherein one of the tracks having a lower track identifier is assigned a higher priority for transmission than one of the tracks having a higher track identifier.

10. The system of claim 5 wherein one of the tracks having a higher track identifier is assigned a higher priority for transmission than one of the tracks having a lower track identifier.

11. The system of claim 1 further comprising a delivery timeout system configured to terminate transmission of the subgroup to a receiver when a delivery timeout duration associated with the subgroup is exceeded.

12. The system of claim 11 wherein the delivery timeout duration is set by a receiver based on a target latency of an application associated with the receiver.

13. The system of claim 11 wherein the delivery timeout duration is set by a sender based on a target latency of an application associated with the sender or receiver.

14. The system of claim 1 further comprising a compression system configured to compress event-based video data assigned to each subgroup prior to transmission by the router.

15. The system of claim 1 wherein the event-based video data is partitioned into objects, each object comprising a fixed number of consecutive events, and the objects are assigned to subgroups according to a temporal order.

16. The system of claim 1 wherein the router is configured to simultaneously transmit the event-based video data to a first processor and a second processor, wherein the first processor receives a subset of the event-based video data and the second processor receives substantially all of the event-based video data.

17. The system of claim 1 wherein the event-based video data processor is further configured to receive data from at least one of a framed camera, a multi-camera apparatus, a LiDAR sensor, a Gaussian representation producer, a point cloud representation producer, or a neural representation producer, and to transcode the received data into an event-based representation.

18. The system of claim 1 wherein the one or more processors are configured to execute a computer vision application and to generate a control directive based on a result of the computer vision application, and to transmit the control directive to the event-based video data processor.

19. A method for event-based video streaming, comprising:
receiving, at an event-based video data processor, intensity-based data from one or more imaging sensors;
generating event-based video data as a function of pixel brightness changes detected in the intensity-based data;
assigning the event-based video data to a subgroup;
transmitting the subgroup to a relay; and
selecting, at the relay, whether to forward the subgroup to one or more receivers as a function of a predetermined latency and a delivery timeout associated with each receiver.

20. The method of claim 19 further comprising detecting and processing events at a latency that is less than a threshold using a low-latency processor.

21. The method of claim 19 further comprising detecting and processing events at a latency that is less than a threshold.

22. The method of claim 19 further comprising asynchronously detecting pixel-level brightness changes and generating a sequence of tuples comprising one or more of spatial coordinate data, timestamp data, and change of polarity data for a detected brightness change.

23. A non-transitory computer-readable medium storing instructions that, when executed by a processor, cause the processor to perform operations for event-based video streaming, the operations comprising:
generating event-based video data based on pixel brightness changes detected by an event-based imaging sensor;
partitioning the event-based video data into a plurality of subgroups within a single track, each subgroup having an associated priority;
transmitting the plurality of subgroups to a relay configured to distribute the subgroups to a plurality of receivers based on a delivery timeout set by each receiver; and
dropping, at the relay, a subgroup for a receiver when the delivery timeout associated with the receiver is exceeded for the subgroup.

24. The non-transitory computer-readable medium of claim 23 wherein the operations further comprise detecting and processing events at a latency that is less than a threshold using a low-latency processor.

25. The non-transitory computer-readable medium of claim 23 wherein the operations further comprise detecting and processing events at a latency that is less than a threshold.
